(19) United States
(12) Patent Application Publication
(10) Pub. No.: US 2026/0259473 A1
(43) Pub. Date: Sep. 3, 2026

(54) OPTICAL AMPLIFICATION APPARATUS AND OPTICAL AMPLIFICATION METHOD

(71) Applicant: NTT, Inc., Tokyo (JP)

(72) Inventors: Shimpei SHIMIZU, Musashino-shi (JP); Takushi KAZAMA, Musashino-shi (JP); Takayuki KOBAYASHI, Musashino-shi (JP); Takeshi UMEKI, Musashino-shi (JP); Yutaka MIYAMOTO, Musashino-shi (JP)

(73) Assignee: NTT, Inc., Tokyo (JP)

(21) Appl. No.: 18/876,025

(22) PCT Filed: Jul. 6, 2022
(86) PCT No.: PCT/JP2022/026791

§ 371 Date: Dec. 17, 2024

(51) Int. Cl. G02F 1/39; H04J 14/06

(52) U.S. Cl. CPC G02F 1/392; H04J 14/06

(57) ABSTRACT

An optical amplification apparatus includes a polarization demultiplexing unit that demultiplexes signal light into polarization components, a first excitation light multiplexing unit that multiplexes excitation light with each polarization component, a first optical amplification unit that generates an optical parametric amplification process to amplify each polarization component, a first excitation light separation unit that separates the excitation light from each polarization component, an unnecessary band separation unit that removes an unnecessary frequency component from each polarization component, a second excitation light multiplexing unit that multiplexes the separated excitation light with each polarization component, a second optical amplification unit that generates an optical parametric amplification process to amplify each polarization component, a second excitation light separation unit that separates the excitation light from each polarization component, and a polarization multiplexing unit that multiplexes each polarization component, and a band-pass filter unit that removes an unnecessary frequency component from the multiplexed signal light. The first optical amplification unit is in a phase matching state in which amplification gain increases as a frequency is separate from a center frequency, and the second optical amplification unit is in a phase matching state in which amplification gain increases near the center frequency.

### TECHNICAL FIELD

The present invention relates to an optical amplification apparatus and an optical amplification method.

### BACKGROUND ART

With the recent start of operation of the fifth generation mobile communication system, spread of rich content such as high-resolution moving images, and the like, communication traffic is increasing exponentially. Thus, continuous increase in capacity of an optical network is required. In optical fiber transmission, transmission capacity per fiber can be improved by widening an optical transmission band. Thus, various studies have been made to implement ultra-wideband wavelength division multiplexing transmission.

In long-distance optical fiber transmission, an optical amplifier is used to compensate for an optical loss generated in an optical fiber. In such a transmission scheme, a transmission band of the optical fiber transmission system is limited to an amplification band of the optical amplifier. General optical amplifiers include an optical amplifier in which an optical fiber is doped with a rare earth element. An erbium-doped fiber amplifier (EDFA) is a typical rare earth-doped optical amplifier. An amplification band of the EDFA is a band of about 4 THz in a C-band (about 1530 to 1565 nm) in which a propagation loss in the optical fiber is small. This is a wavelength band commonly used in long-distance optical communication. In order to extend the transmission band, for example, a method is considered in which different kinds of amplifiers in which the amplification band is shifted by changing a rare earth element with which the optical fiber is to be doped are arranged in parallel. However, there is a problem that gain is low and a noise figure is high in a band other than the C-band. In addition, in consideration of cost and operation of a transmission system and an excessive optical loss caused by dividing an optical signal into a large number of band components, it is desirable that amplification can be performed in a wide band using a single optical amplifier.

Under such a background, an optical parametric amplifier (OPA) has attracted attention. The OPA is an amplifier that amplifies input light using a nonlinear optical effect in a medium such as lithium niobate that is a second-order nonlinear optical medium or an optical fiber that is a third-order nonlinear optical medium. An amplification band of the OPA depends on a phase matching characteristic in a nonlinear optical medium to be used as an amplification medium. By achieving a wideband phase matching state by design of a medium, the OPA can perform wideband amplification exceeding the amplification band of the EDFA. In addition, the center of the phase matching characteristic can be designed to have various wavelengths. It is therefore also possible to amplify various communication wavelength bands other than the C-band and L-band used in related art.

In the second-order nonlinear optical medium in which a second harmonic wave is used as excitation light for parametric amplification, a frequency difference between light to be amplified and the excitation light is large, and thus, a difference in an effective refractive index with respect to each component is large. It is therefore not easy to make a design so as to satisfy a phase matching condition. In addition, a wideband phase matching characteristic can be achieved by a technique called quasi-phase matching (QPM) by a periodically poled structure in which regions in which signs of nonlinear susceptibility are inverted are alternately formed. In order to achieve both the wideband characteristic and high gain, a configuration using periodically poled lithium niobate (PPLN) which is less likely to cause an unnecessary nonlinear optical effect as an amplification medium is promising. There is a possibility of wideband amplification relay transmission exceeding 10 THz with amplification gain of 15 dB with the OPA with a PPLN waveguide (see, for example, Non Patent Literature 1).

In the second-order nonlinear medium including the PPLN, an optical parametric amplification process occurs only in a specific polarization state. Thus, a polarization diversity configuration is required in which a polarized wave of input light is divided into two orthogonal components before amplification, and then each component is amplified and re-multiplexed. In addition, even in a third-order nonlinear optical effect, gain according to a polarization state of excitation light is generated. In order to implement stable amplification independent of polarization, it is desirable to use a similar polarization diversity configuration.

In the OPA, idler light that is phase conjugate light of signal light is generated at a frequency symmetrical to the signal light with a center frequency of an amplification band as a boundary when the input signal light is amplified. For signal transmission, it is only necessary to transmit either idler light or original signal light. Thus, light components not to be used for transmission are amplified and then cut by a band-pass filter (BPF). In this event, if the idler light is extracted as a new transmission optical signal, the OPA also functions as an optical phase conjugate converter (see, for example, Non Patent Literature 2) and a wavelength converter (see, for example, Patent Literature 1). One of the features of the OPA is that the OPA can not only function as a simple optical amplifier but also perform such various kinds of optical signal processing.

On the other hand, it is necessary to leave a band in which idler light is to be generated at the time of amplification by the OPA, and thus, signal light cannot be arranged in the band. Thus, in order to use the amplification band of the OPA to the maximum, it is necessary to divide signal light into two bands with a center frequency as a boundary, and after the divided bands are amplified by different nonlinear media, an unnecessary light component, that is, either the original signal light or idler light is cut by a wavelength filter, and light components of the respective bands is re-multiplexed.

### CITATION LIST

### Patent Literature

Patent Literature 1: JP 2020-86031 A

### Non Patent Literature

Non Patent Literature 1: T. Kobayashi et al., “Wide-Band Inline-Amplified WDM Transmission Using PPLN-Based Optical Parametric Amplifier”, IEEE Journal of Lightwave Technology, Vol. 39, No. 3, pp. 787-794, February 2021.

Non Patent Literature 2: T. Umeki et al., “Simultaneous nonlinearity mitigation in 92×180-Gbit/s PDM-16QAM transmission over 3840 km using PPLN-based guard-band-less optical phase conjugation”, Optics Express, Vol. 24, No. 15, 16945-16951, 2016.

### SUMMARY OF INVENTION

### Technical Problem

In amplification relay transmission, an optical amplifier needs to compensate for a transmission loss of an optical signal in the entire band to be used. In addition, even in single-span transmission, it is necessary to have amplification gain sufficient for securing a signal-to-noise ratio necessary for reception of an optical signal in a band to be used. Hereinafter, an amplification band of an optical amplifier having such desired amplification gain will be referred to as an effective amplification band.

A phase matching band of a nonlinear optical medium that determines an amplification band of the OPA is determined by wavelength dependency of a refractive index of the medium and can be adjusted by parameter design at the time of manufacturing the medium or a temperature state. In a case of a temperature that provides an optimum phase matching condition in a band near the center frequency, a gain spectrum of the OPA has a flat characteristic near the center frequency. In addition, if the temperature of the medium is changed and a phase matching state is changed, the gain near the center frequency decreases and gain at a frequency separate from the center increases. As a result, the effective amplification band can be widened. If the temperature is changed in a direction opposite to a direction in which the effective amplification band is widened, the gain spectrum is changed so that a band of the flat gain near the center frequency is narrowed.

Widening of the effective amplification band by temperature control reaches a limit at a time point when the gain near the center frequency falls below desired gain. Means for securing amplification gain by connecting two OPAs in cascade is also conceivable. However, there are concerns about influence of increase in power consumption due to necessity of additional excitation light and signal distortion due to gain saturation in the subsequent OPA.

In view of the above circumstances, an object of the present invention is to provide an optical amplification apparatus and an optical amplification method capable of widening an amplification band of signal light while reducing increase in power consumption and signal distortion.

### Solution to Problem

An optical amplification apparatus according to one aspect of the present invention includes a polarization demultiplexing unit that demultiplexes signal light into first polarized signal light and second polarized signal light which are two orthogonal polarization components, a first excitation light multiplexing unit that multiplexes excitation light with each of the first polarized signal light and the second polarized signal light, a first optical amplification unit that generates an optical parametric amplification process to amplify the first polarized signal light and the second polarized signal light multiplexed with the excitation light by the first excitation light multiplexing unit, a first excitation light separation unit that separates the excitation light from each of the first polarized signal light and the second polarized signal light amplified by the first optical amplification unit, an unnecessary band separation unit that removes an unnecessary frequency component from each of the first polarized signal light and the second polarized signal light from which the excitation light has been separated by the first excitation light separation unit, a second excitation light multiplexing unit that multiplexes the first polarized signal light from which the unnecessary frequency component has been removed by the unnecessary band separation unit and the excitation light separated from the first polarized signal light by the first excitation light separation unit and multiplexes the second polarized signal light from which the unnecessary frequency component has been removed by the unnecessary band separation unit and the excitation light separated from the second polarized signal light by the first excitation light separation unit, a second optical amplification unit that generates an optical parametric amplification process to amplify the first polarized signal light and the second polarized signal light multiplexed with the excitation light by the second excitation light multiplexing unit, a second excitation light separation unit that separates the excitation light from each of the first polarized signal light and the second polarized signal light amplified by the second optical amplification unit, a polarization multiplexing unit that outputs signal light obtained by multiplexing the first polarized signal light and the second polarized signal light from which the excitation light has been separated by the second excitation light separation unit, and a band-pass filter unit that removes an unnecessary frequency component from the signal light output from the polarization multiplexing unit, in which the first optical amplification unit is in a phase matching state in which amplification gain increases as a frequency is separate from a center frequency that is ½ of a frequency of the excitation light and, the second optical amplification unit is in a phase matching state in which amplification gain increases near the center frequency.

An optical amplification method according to one aspect of the present invention includes a polarization demultiplexing step of demultiplexing signal light into first polarized signal light and second polarized signal light which are two orthogonal polarization components, a first excitation light multiplexing step of multiplexing excitation light with each of the first polarized signal light and the second polarized signal light, a first optical amplification step of generating an optical parametric amplification process to amplify the first polarized signal light and the second polarized signal light multiplexed with the excitation light in the first excitation light multiplexing step, a first excitation light separation step of separating the excitation light from each of the first polarized signal light and the second polarized signal light amplified in the first optical amplification step, an unnecessary band separation step of removing an unnecessary frequency component from each of the first polarized signal light and the second polarized signal light from which the excitation light has been separated in the first excitation light separation step, a second excitation light multiplexing step of multiplexing the first polarized signal light from which the unnecessary frequency component has been removed in the unnecessary band separation step and the excitation light separated from the first polarized signal light in the first excitation light separation step and multiplexing the second polarized signal light from which the unnecessary frequency component has been removed in the unnecessary band separation step and the excitation light separated from the second polarized signal light in the first excitation light separation step, a second optical amplification step of generating an optical parametric amplification process to amplify the first polarized signal light and the second polarized signal light multiplexed with the excitation light in the second excitation light multiplexing step, a second excitation light separation step of separating the excitation light from each of the first polarized signal light and the second polarized signal light amplified in the second optical amplification step, a polarization multiplexing step of outputting signal light obtained by multiplexing the first polarized signal light and the second polarized signal light from which the excitation light has been separated in the second excitation light separation step, and a filtering step of removing an unnecessary frequency component from the signal light output in the polarization multiplexing step, in which in the first optical amplification step, a state is a phase matching state in which amplification gain increases as a frequency is separate from a center frequency that is ½ of a frequency of the excitation light and, in the second optical amplification step, a state is a phase matching state in which amplification gain increases near the center frequency.

### Advantageous Effects of Invention

According to the present invention, it is possible to widen an amplification band of signal light while reducing increase in power consumption and signal distortion.

### BRIEF DESCRIPTION OF DRAWINGS

FIG. 1 A diagram illustrating a configuration example of an optical amplifier according to a first embodiment of the present invention.

FIG. 2 A diagram illustrating an example of amplification gain of a nonlinear medium in the first embodiment.

FIG. 3 A diagram illustrating comparison between an amplification band spectrum of the optical amplifier according to the first embodiment and an amplification band spectrum of an optical amplifier of the related art.

FIG. 4 A diagram illustrating a configuration example of the optical amplifier according to the first embodiment.

FIG. 5 A diagram illustrating a configuration example of the optical amplifier according to the first embodiment.

FIG. 6 A diagram illustrating a configuration example of an optical amplifier according to a second embodiment.

FIG. 7 A diagram illustrating a configuration example of the optical amplifier according to the second embodiment.

### DESCRIPTION OF EMBODIMENTS

Hereinafter, embodiments of the present invention will be described in detail with reference to the drawings. The present embodiment relates to an optical signal amplification technique using optical parametric amplification.

An optical amplification apparatus of the present embodiment is an OPA having a configuration in which nonlinear optical media having a complementary phase matching characteristic (gain spectrum) are cascade-connected. In the nonlinear optical medium in the first stage, a medium temperature is adjusted so as to amplify a frequency band separate from the center frequency at least in a frequency band to be amplified. In this event, unlike the configuration in the related art, gain near the center frequency may be lower than desired gain. In the nonlinear optical medium in the subsequent stage, a band near the center frequency that has not been amplified by the medium in the first stage, that is, a band that has not achieved desired gain in amplification by the medium in the first stage is complementarily amplified. In this event, the amplification band is intentionally narrowed by controlling a temperature of the medium in the subsequent stage in a direction opposite to that of the medium in the first stage. In this way, input optical power to the medium in the subsequent stage is substantially reduced, and even with weak excitation light, gain sufficient to complement a gain characteristic of the medium in the first stage can be obtained. Thus, the excitation light used in the nonlinear optical medium in the first stage can be reused as is, and no additional excitation light is required. In other words, the effective amplification band can be extended without increasing power consumption.

### First Embodiment

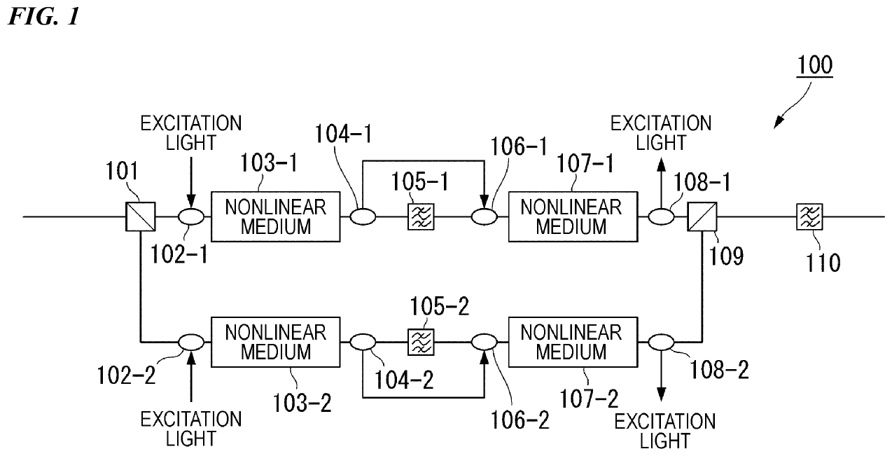

A first embodiment of the present invention will be described with reference to FIGS. 1 to 5.

FIG. 1 is a diagram illustrating a configuration of an optical amplifier 100 according to the first embodiment. The optical amplifier 100 is an OPA. The optical amplifier 100 includes a polarization demultiplexing unit 101, an excitation light multiplexing unit 102-1, an excitation light multiplexing unit 102-2, a nonlinear medium 103-1, a nonlinear medium 103-2, an excitation light separation unit 104-1, an excitation light separation unit 104-2, an unnecessary band separation unit 105-1, an unnecessary band separation unit 105-2, an excitation light multiplexing unit 106-1, an excitation light multiplexing unit 106-2, a nonlinear medium 107-1, a nonlinear medium 107-2, an excitation light separation unit 108-1, an excitation light separation unit 108-2, a polarization multiplexing unit 109, and a band-pass filter 110.

The polarization demultiplexing unit 101 separates input signal light into orthogonal polarization components. One of the signal light divided into two orthogonal polarization components is referred to as first polarized signal light, and the other signal light is referred to as second polarized signal light. The polarization demultiplexing unit 101 outputs the first polarized signal light to the excitation light multiplexing unit 102-1 and inputs the second polarized signal light to the excitation light multiplexing unit 102-2.

The excitation light multiplexing unit 102-i (i=1, 2) multiplexes the i-th polarized signal light input from the polarization demultiplexing unit 101 with the excitation light. The excitation light multiplexing unit 102-i outputs the i-th polarized signal light multiplexed with the excitation light to the nonlinear medium 103-i. The nonlinear medium 103-i is an optical amplification unit using a nonlinear optical medium. The nonlinear medium 103-i generates an optical parametric process to amplify the i-th polarized signal light input from the excitation light multiplexing unit 102-i. The nonlinear medium 103-i outputs the amplified i-th polarized signal light to the excitation light separation unit 104-i.

The excitation light separation unit 104-i inputs the i-th polarized signal from the nonlinear medium 103-i and separates the excitation light from the input i-th polarized signal light. The excitation light separation unit 104-i outputs the i-th polarized signal light from which the excitation light has been separated to the unnecessary band separation unit 105-i and outputs the excitation light to the excitation light multiplexing unit 106-i. The unnecessary band separation unit 105-i inputs the i-th polarized signal light from the excitation light separation unit 104-i, removes an unnecessary frequency component generated in the optical parametric process from the input i-th polarized signal light and then outputs it to the excitation light multiplexing unit 106-i.

The excitation light multiplexing unit 106-i multiplexes the excitation light separated by the excitation light separation unit 105-i with the i-th polarized signal light from which the unnecessary frequency component has been removed by the unnecessary band separation unit 104-i. The excitation light multiplexing unit 106-i outputs the i-th polarized signal light multiplexed with the excitation light to the nonlinear medium 107-i. The nonlinear medium 107-i is an optical amplification unit using a nonlinear optical medium. The nonlinear medium 107-i generates an optical parametric process to amplify the i-th polarized signal light input from the excitation light multiplexing unit 106-i. The nonlinear medium 107-i outputs the amplified i-th polarization signal light to the excitation light separation unit 108-i. The excitation light separation unit 108-i inputs the i-th polarized signal light from the nonlinear medium 107-i and separates the excitation light from the input i-th polarized signal light. The excitation light separation unit 108-i outputs the i-th polarized signal light from which the excitation light has been separated to the polarization multiplexing unit 109.

The polarization multiplexing unit 109 multiplexes the first polarized signal light input from the excitation light separation unit 108-1 with the second polarized signal light input from the excitation light separation unit 108-2 and outputs the multiplexed signal light to the band-pass filter 110. The band-pass filter 110 receives the signal light from the polarization multiplexing unit 109 and removes an unnecessary frequency component generated in the optical parametric process in each of the nonlinear medium 107-1 and the nonlinear medium 107-2 from the received signal light. The band-pass filter 110 outputs signal light from which the unnecessary frequency component has been removed.

The signal light input to the optical amplifier 100 is first divided into two bands with the center frequency of the amplification band as a boundary. This is because idler light, which is phase conjugate light of signal light, is generated at a frequency symmetric with respect to the center frequency in association with parametric amplification. Thereafter, each signal light divided into two bands is separated into orthogonal polarization components by the polarization demultiplexing unit 101. This is because a nonlinear phenomenon in the nonlinear medium has polarization dependence. The signal light divided into two orthogonal polarization components is multiplexed with the excitation light by the excitation light multiplexing units 102-1 and 102-2 and parametrically amplified by the nonlinear media 103-1, 103-2, 107-1, and 107-2. After the amplification, the excitation light is separated from the signal light of each polarization component by the excitation light separation units 108-1 and 108-2. After the separation of the excitation light, the signal light of each polarization component is subjected to polarization multiplexing again by the polarization multiplexing unit 109.

Multiplexing of the excitation light by the excitation light multiplexing units 102-1 and 102-2 and demultiplexing of the excitation light by the excitation light separation units 108-1 and 108-2 are performed using a wavelength multiplexing filter, a dichroic mirror, or the like. Of the signal light and the idler light, components not to be used for transmission are cut by the band-pass filter 110. Usually, the band-pass filter 110 extracts a signal light component in the same band as the signal light input to the optical amplifier 100 and outputs the extracted signal light component to the subsequent stage. However, the band-pass filter 110 may extract idler light and output the extracted idler light to the subsequent stage. As a result, the optical amplifier 100 can be used as a phase conjugate converter or a wavelength converter.

In the present embodiment, two nonlinear media 103-i and 107-i are arranged in a path of each polarization component. Temperatures of the two nonlinear media 103-i and the nonlinear medium 107-i are adjusted by a Peltier element, a heater, or the like, attached to the media so as to have complementary gain spectra. The excitation light used for amplification by the nonlinear medium 103-i in the first stage is separated by the excitation light separation unit 104-i, and then multiplexed with the signal light again by the excitation light multiplexing unit 106-i in the subsequent stage and used for amplification by the nonlinear medium 107-i. Note that demultiplexing of the excitation light by the excitation light separation unit 104-i and multiplexing of the excitation light by the excitation light multiplexing unit 106-i are performed using a wavelength multiplexing filter, a dichroic mirror, or the like. The excitation light separation unit 104-i between the nonlinear medium 103-i and the nonlinear medium 107-i passes the same band as the signal light input to the optical amplifier 100 or passes the band of the idler light.

Usually, power of the excitation light used once is reduced due to slight attenuation associated with a nonlinear process in the medium, loss at the excitation light separation unit, and loss at the excitation light multiplexing unit. In addition, in order to linearly amplify the signal light having been amplified once and increased in optical power again, higher excitation light optical power is required. For the above reasons, usually, reuse of excitation light immediately causes gain saturation due to pump depression and causes nonlinear distortion in the signal light. However, as in the present embodiment, by setting phase matching characteristic of the nonlinear medium 107-i in the subsequent stage to a narrow band, the excitation light is not consumed in the band outside the signal light. In other words, the input signal optical power to the nonlinear medium 107-i in the subsequent stage can be substantially regarded to be lower than true input power, and thus, gain saturation can be suppressed. In addition, only the band near the center needs to be amplified with small gain, which is also a factor of enabling such a configuration.

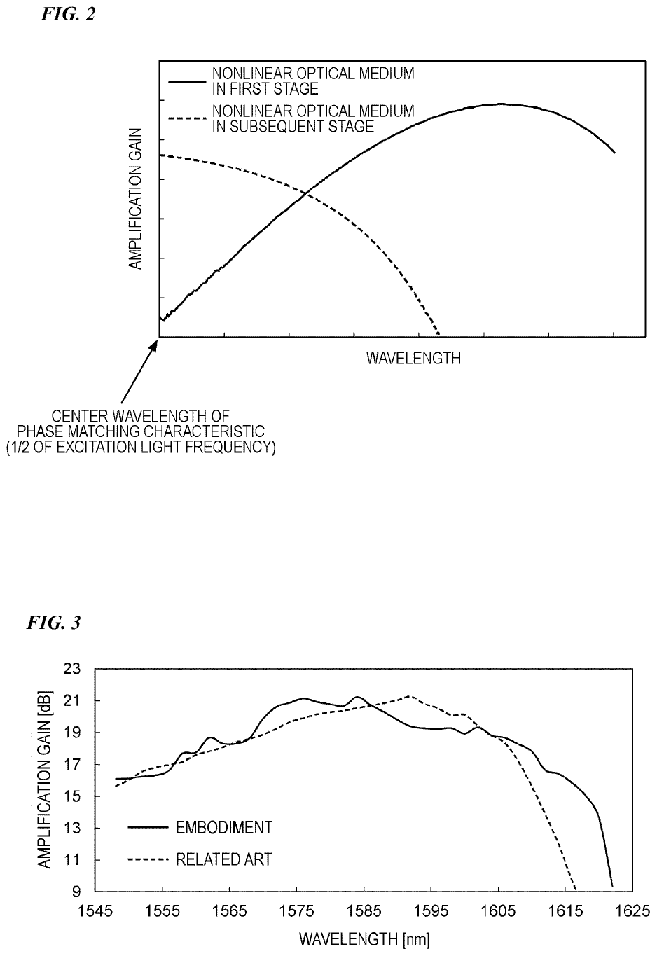

FIG. 2 is a diagram illustrating an example of amplification gain of the nonlinear medium 103-i in the first stage and amplification gain of the nonlinear medium 107-i in the subsequent stage. In the nonlinear medium 103-i in the first stage, the amplification gain around the center wavelength of the phase matching characteristic is low, and accordingly, the amplification gain is large in a wavelength separate from the center wavelength. The center wavelength of the phase matching characteristic is a wavelength corresponding to a center frequency which is ½ of the frequency of the excitation light. In addition, the nonlinear medium 107-i in the subsequent stage has an amplification gain spectrum that complementarily amplifies around the center wavelength of the nonlinear medium 103-i in the first stage.

FIG. 3 is a diagram illustrating comparison between the amplification gain spectrum of the optical amplifier 100 of the present embodiment illustrated in FIG. 1 and the amplification gain spectrum of the optical amplifier of the related art. The optical amplifier of the related art is an OPA configuration including a single nonlinear medium. Amplification gain when continuous light was input using a PPLN waveguide having a center wavelength (frequency of ½ of the excitation light frequency) of a phase matching characteristic of 1545.32 nm was measured by sweeping a wavelength of the input light. In both the optical amplifier 100 of the present embodiment and the optical amplifier of the related art, temperature control was performed so as to maximize a band in which gain of 15 dB is obtained. The input power of the excitation light is the same in the present embodiment and the related art. According to FIG. 3, the optical amplifier 100 having the configuration of the present embodiment can extend the effective amplification band by about 8 nm as compared with the optical amplifier of the related art. In the present embodiment, such band extension can be implemented with high power efficiency without adding excitation light or increasing the output.

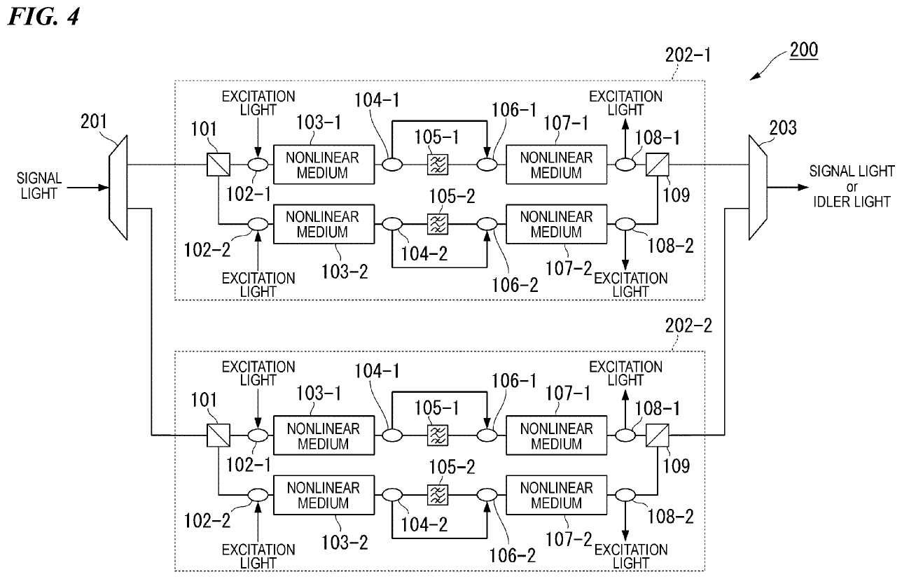

FIG. 4 is a diagram illustrating a configuration of an optical amplifier 200. The optical amplifier 200 is configured to use the entire band extending from the center frequency of the phase matching characteristic of the OPA to a low frequency side and a high frequency side. In FIG. 4, the same components as those of the optical amplifier 100 illustrated in FIG. 1 are denoted by the same reference numerals, and description thereof will be omitted. The optical amplifier 200 includes a band demultiplexing unit 201, an OPA 202-1, an OPA 202-2, and a band multiplexing unit 203.

The band demultiplexing unit 201 demultiplexes signal light input to the optical amplifier 200 into two bands with a center frequency as a boundary. The band demultiplexing unit 201 outputs one demultiplexed signal light to the OPA 202-1 and outputs the other demultiplexed signal light to the OPA 202-2.

Each of the OPA 202-1 and the OPA 202-2 has a configuration in which the band-pass filter 110 is removed from the optical amplifier 100 illustrated in FIG. 1. The polarization demultiplexing unit 101 of the OPA 202-1 and the polarization demultiplexing unit 101 of the OPA 202-2 receive signal light from the band demultiplexing unit 201. Further, the polarization multiplexing unit 109 of the OPA 202-1 and the polarization multiplexing unit 109 of the OPA 202-2 output the polarization-multiplexed signal light to the band multiplexing unit 203.

The band multiplexing unit 203 multiplexes the signal light input from the polarization multiplexing unit 109 of the OPA 202-1 and the signal light input from the polarization multiplexing unit 109 of the OPA 202-2. The band multiplexing unit 203 cuts a component not to be used for transmission from the multiplexed signal light by a filter, extracts signal light of a band to be used for transmission and outputs the signal light. As a result, the signal light from which the idler light has been cut or the idler light from which the signal light has been cut is output from the band multiplexing unit 203.

In the OPA, it is necessary to leave a band in which idler light is to be generated. It is therefore necessary to have a configuration in which signal light is divided into two bands with the center frequency as a boundary, processed, and then multiplexed again. Thus, in the optical amplifier 200, another configuration of the optical amplifier 100 described above is prepared, and the configurations are connected in parallel via a band multiplexing/demultiplexing filter including the band demultiplexing unit 201 and the band multiplexing unit 203. The configuration of the optical amplifier 100 corresponds to the OPA 202-1 and the OPA 202-2.

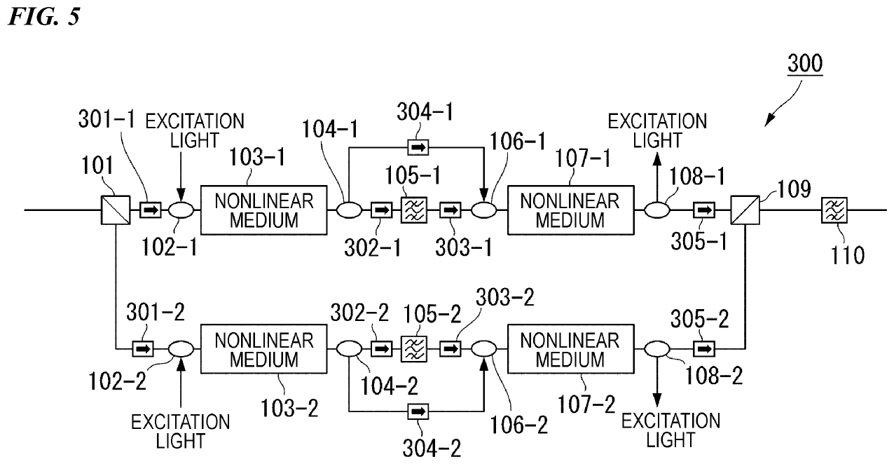

Isolators may be provided before and after the nonlinear medium to suppress reflected light from the nonlinear medium. FIG. 5 illustrates an example in which isolators are provided.

FIG. 5 is a configuration diagram of an OPA 300. In FIG. 5, the same components as those of the optical amplifier 100 illustrated in FIG. 1 are denoted by the same reference numerals, and description thereof will be omitted. The OPA 300 illustrated in FIG. 5 differs from the optical amplifier 100 illustrated in FIG. 1 in that the OPA includes isolators 301-1, 301-2, 302-1, 302-2, 303-1, 303-2, 304-1, 304-2, 305-1, and 305-2.

The isolator 301-i (i=1, 2) is provided between the polarization demultiplexing unit 101 and the excitation light multiplexing unit 102-i. The isolator 301-i passes the i-th polarized signal light in a direction from the polarization demultiplexing unit 101 to the excitation light multiplexing unit 102-i and blocks light in a direction from the excitation light multiplexing unit 102-i to the polarization demultiplexing unit 101. The isolator 302-i is provided between the excitation light separation unit 104-i and the unnecessary band separation unit 105-i. The isolator 302-i passes the i-th polarized signal light in a direction from the excitation light separation unit 104-i to the unnecessary band separation unit 105-i and blocks light in a direction from the unnecessary band separation unit 105-i to the excitation light separation unit 104-i. The isolator 303-i is provided between the unnecessary band separation unit 105-i and the excitation light multiplexing unit 106-i. The isolator 303-i passes the i-th polarized signal light in a direction from the unnecessary band separation unit 105-i to the excitation light multiplexing unit 106-i and blocks light in a direction from the excitation light multiplexing unit 106-i to the unnecessary band separation unit 105-i.

The isolator 304-i is provided between the excitation light separation unit 104-i and the excitation light multiplexing unit 106-i. The isolator 304-i passes the excitation light in a direction from the excitation light separation unit 104-i to the excitation light multiplexing unit 106-i and blocks light in a direction from the excitation light multiplexing unit 106-i to the excitation light separation unit 104-i. The isolator 305-i is provided between the excitation light separation unit 108-i and the polarization multiplexing unit 109. The isolator 305-i passes the i-th polarized signal light in a direction from the excitation light separation unit 108-i to the polarization multiplexing unit 109 and blocks light in a direction from the polarization multiplexing unit 109 to the excitation light separation unit 108-i.

As illustrated in FIG. 5, by placing isolators immediately before, immediately after, or both of the nonlinear media 103-1, 103-2, 107-1, and 107-2, reflected light can be effectively suppressed. The isolators may be provided only immediately before, immediately after, or both of the nonlinear media 103-1 and 103-2 in the first stage and the nonlinear media 107-1 and 107-2 in the subsequent stage. In addition, it is desirable to arrange isolators also in a process of separating and re-multiplexing the excitation light to avoid multiple reflection of the excitation light between the two media.

### Second Embodiment

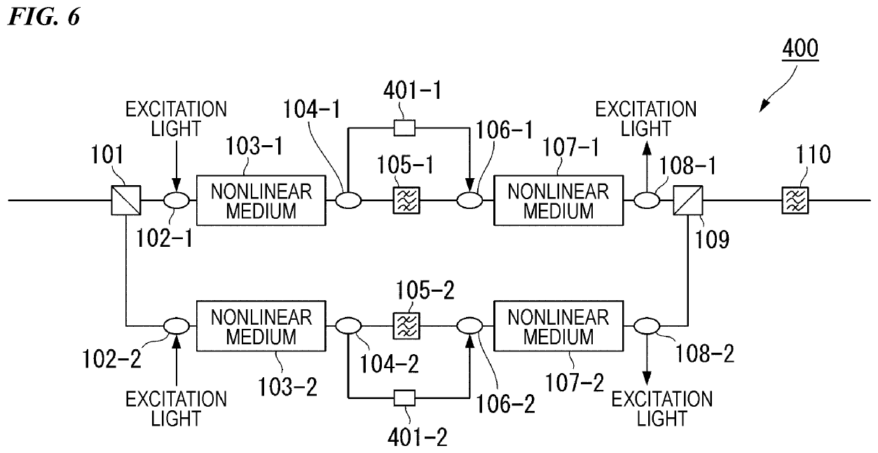

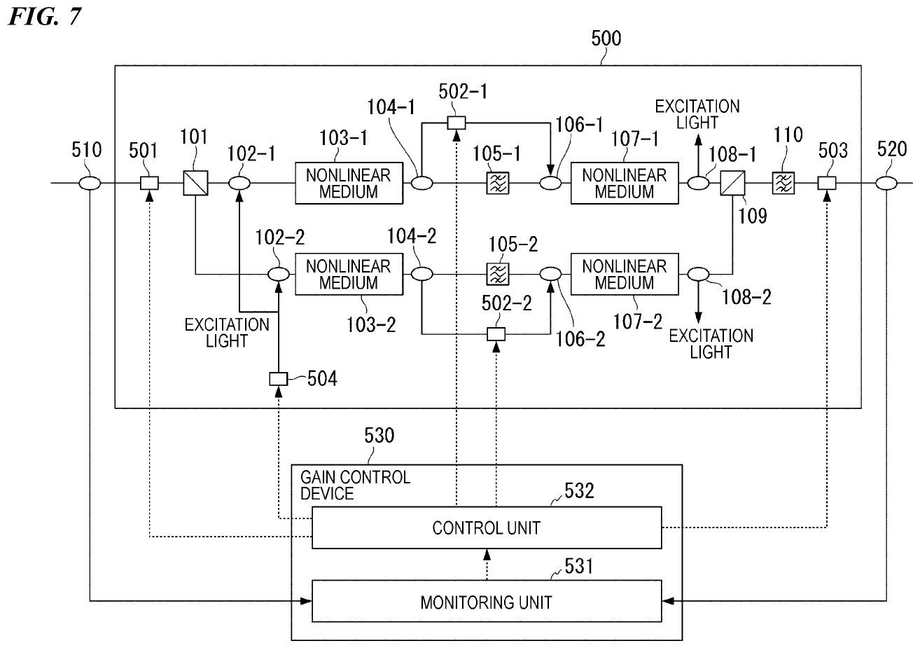

In a second embodiment, optical power of excitation light input to the nonlinear medium in the subsequent stage is adjusted. The second embodiment of the present invention will be described with reference to FIGS. 6 and 7.

FIG. 6 is a diagram illustrating a configuration example of an optical amplifier 400 according to the second embodiment. In FIG. 6, the same components as those of the optical amplifier 100 according to the first embodiment illustrated in FIG. 1 are denoted by the same reference numerals, and description thereof will be omitted. The optical amplifier 400 illustrated in FIG. 6 is different from the optical amplifier 100 illustrated in FIG. 1 in that an optical attenuator 401-1 is provided between the excitation light separation unit 104-1 and the excitation light multiplexing unit 106-1, and an optical attenuator 401-2 is provided between the excitation light separation unit 104-2 and the excitation light multiplexing unit 106-2. The optical attenuator 401-i (i=1, 2) attenuates the excitation light separated by the excitation light separation unit 104-i and outputs the excitation light to the excitation light multiplexing unit 106-i.

In a case where the optical power of the excitation light input to the nonlinear medium 107-i in the subsequent stage is too strong, the gain increases, but in general, gain saturation tolerance with respect to the input signal optical power decreases. It is therefore desirable to attenuate the optical power of the excitation light input to the nonlinear medium 107-i in the subsequent stage to such an extent that minimum necessary gain can be obtained. Thus, in the second embodiment, as illustrated in FIG. 6, an optical attenuator 401-i is disposed in an excitation light path between the nonlinear medium 103-i in the first stage and the nonlinear medium 107-i in the subsequent stage.

In addition, an automatic gain control (AGC) is usually mounted on the optical amplifier. FIG. 7 is a diagram illustrating a configuration example of an optical amplifier 500 on which the automatic gain control is mounted. In FIG. 7, the same components as those of the optical amplifier 100 of the first embodiment illustrated in FIG. 1 are denoted by the same reference numerals, and description thereof will be omitted. The optical amplifier 500 illustrated in FIG. 7 is different from the optical amplifier 100 illustrated in FIG. 1 in that it further includes variable optical attenuators (VOA) 501, 502-1, 502-2, and 503. The variable optical attenuator 501 is provided in a preceding stage of the polarization demultiplexing unit 101. The variable optical attenuator 502-1 is provided between the excitation light separation unit 104-1 and the excitation light multiplexing unit 106-1. The variable optical attenuator 502-2 is provided between the excitation light separation unit 104-2 and the excitation light multiplexing unit 106-2. The variable optical attenuator 503 is provided in a subsequent stage of the band-pass filter 110. In addition, FIG. 7 illustrates excitation light to be input to the excitation light multiplexing unit 102-1 and a light source 504 of the excitation light to be input to the excitation light multiplexing unit 102-2. An optical tap 510 is connected to a preceding stage of the optical amplifier 500, and the optical tap 520 is connected to a subsequent stage of the optical amplifier 500. In addition, the optical amplifier 500, the optical tap 510, and the optical tap 520 are connected to a gain control device 530. The gain control device 530 is an AGC.

The optical tap 510 branches part of the signal light input to the optical amplifier 500. The optical tap 510 outputs the branched signal light to the gain control device 530 and outputs the remaining branched signal light to the variable optical attenuator 501 of the optical amplifier 500. The variable optical attenuator 501 attenuates the signal light input from the optical tap 510 and outputs the signal light to the polarization demultiplexing unit 101. A variable light attenuator 502-i (i=1, 2) attenuates the excitation light separated by the excitation light separation unit 104-2 and outputs the excitation light to the excitation light multiplexing unit 106-i. The variable optical attenuator 503 attenuates and outputs the signal light output from the band-pass filter 110. The optical tap 520 branches part of the signal light attenuated by the variable optical attenuator 503 of the optical amplifier 500. The optical tap 520 outputs the branched signal light to the gain control device 530 and outputs the remaining branched signal light.

The gain control device 530 includes a monitoring unit 531 and a control unit 532. The monitoring unit 531 monitors the signal light branched by the optical tap 510 and the signal light branched by the optical tap 520. The control unit 532 controls gain when the signal light is attenuated in each of the variable optical attenuators 501, 502-1, 502-2, and 503 and controls excitation light power by changing an injection current to the light source 504 on the basis of a monitoring result in the monitoring unit 531. With the configuration illustrated in FIG. 7, AGC can be performed not only by the power injected into the excitation light but also by the temperature of the nonlinear medium and control of the VOA for the excitation light described above.

As described above, according to the present embodiment, by the OPA configuration in which two nonlinear media having a complementary gain characteristic are connected, the amplification band can be made a wideband with high power efficiency without requiring addition of excitation light or high output.

According to the above-described embodiment, the optical amplification apparatus includes a polarization demultiplexing unit, a first excitation light multiplexing unit, a first optical amplification unit, a first excitation light separation unit, an unnecessary band separation unit, a second excitation light multiplexing unit, a second optical amplification unit, a second excitation light separation unit, a polarization multiplexing unit, and a band-pass filter unit. The polarization demultiplexing unit corresponds to, for example, the polarization demultiplexing unit 101 of the embodiment. The first excitation light multiplexing unit corresponds to, for example, the excitation light multiplexing units 102-1 and 102-2 of the embodiment. The first optical amplification unit corresponds to, for example, the nonlinear media 103-1 and 103-2 of the embodiment. The first excitation light separation unit corresponds to, for example, the excitation light separation units 104-1 and 104-2 of the embodiment. The unnecessary band separation unit corresponds to, for example, the unnecessary band separation units 105-1 and 105-2 of the embodiment. The second excitation light multiplexing unit corresponds to, for example, the excitation light multiplexing units 106-1 and 106-2 of the embodiment. The second optical amplification unit corresponds to, for example, the nonlinear media 107-1 and 107-2 of the embodiment. The second excitation light separation unit corresponds to, for example, the excitation light separation units 108-1 and 108-2 of the embodiment. The polarization multiplexing unit corresponds to, for example, the polarization multiplexing unit 109 of the embodiment. The band-pass filter unit corresponds to, for example, the band-pass filter 110 of the embodiment.

The polarization demultiplexing unit demultiplexes the signal light into first polarized signal light and second polarized signal light which are two orthogonal polarization components. The first excitation light multiplexing unit multiplexes the excitation light with each of the first polarized signal light and the second polarized signal light. The first optical amplification unit generates an optical parametric amplification process to amplify the first polarized signal light and the second polarized signal light multiplexed with the excitation light by the first excitation light multiplexing unit. The first excitation light separation unit separates the excitation light from each of the first polarized signal light and the second polarized signal light amplified by the first optical amplification unit. The unnecessary band separation unit removes an unnecessary frequency component from each of the first polarized signal light and the second polarized signal light from which the excitation light has been separated by the first excitation light separation unit. The second excitation light multiplexing unit multiplexes the first polarized signal light from which the unnecessary frequency component has been removed by the unnecessary band separation unit and the excitation light separated from the first polarized signal light by the first excitation light separation unit and multiplexes the second polarized signal light from which the unnecessary frequency component has been removed by the unnecessary band separation unit and the excitation light separated from the second polarized signal light by the first excitation light separation unit. The second optical amplification unit generates an optical parametric amplification process to amplify the first polarized signal light and the second polarized signal light multiplexed with the excitation light by the second excitation light multiplexing unit. The second excitation light separation unit separates the excitation light from each of the first polarized signal light and the second polarized signal light amplified by the second optical amplification unit. The polarization multiplexing unit outputs signal light obtained by multiplexing the first polarized signal light and the second polarized signal light from which the excitation light has been separated by the second excitation light separation unit. The band-pass filter unit removes an unnecessary frequency component from the signal light output from the polarization multiplexing unit. The first optical amplification unit is in a phase matching state in which amplification gain increases as a frequency is separate from a center frequency that is ½ of a frequency of the excitation light. The second optical amplification unit is in a phase matching state in which amplification gain increases near the center frequency. The second optical amplification unit complementarily amplifies the first polarized signal light and the second polarized signal light which do not have predetermined amplification gain in the first optical amplification unit in the frequency band to be amplified.

The optical amplification apparatus may further include an adjustment unit. The adjustment unit corresponds to, for example, the optical attenuators 401-1 and 401-2 of the embodiment. The adjustment unit adjusts optical power of the excitation light to be output from the first excitation light separation unit to the second excitation light multiplexing unit. An attenuation amount of the excitation light in the adjustment unit may be fixed or variable.

The optical amplification apparatus may further include a control unit. The control unit corresponds to, for example, the gain control device 530 of the embodiment. The control unit controls gain of the adjustment unit according to the monitoring result of the signal light before being separated by the polarization demultiplexing unit and the signal light output from the band-pass filter unit.

The optical amplification apparatus may further include an isolator that passes light in a direction from the first optical amplification unit to the second optical amplification unit and blocks light in a direction from the second optical amplification unit to the first optical amplification unit in one or both of a preceding stage and a subsequent stage of one or both of the first optical amplification unit and the second optical amplification unit.

The band-pass filter unit passes amplified signal light or idler light.

Although the embodiments of the present invention have been described in detail with reference to the drawings so far, specific configurations are not limited to these embodiments, and include designs, and the like, without departing from the gist of the invention.

### REFERENCE SIGNS LIST

100 Optical amplifier
101 Polarization demultiplexing unit
102-1, 102-2 Excitation light multiplexing unit
103-1, 103-2 Nonlinear medium
104-1, 104-2 Excitation light separation unit
105-1, 105-2 Unnecessary band separation unit
106-1, 106-2 Excitation light multiplexing unit
107-1, 107-2 Nonlinear medium
108-1, 108-2 Excitation light separation unit
109 Polarization multiplexing unit
110 Band-pass filter
200 Optical amplifier
201 Band demultiplexing unit
203 Band multiplexing unit
301-1, 301-2, 302-1, 302-2, 303-1, 303-2, 304-1, 304-2,
305-1, 305-2 Isolator
400 Optical amplifier
401-1, 401-2 Optical attenuator
500 Optical amplifier
501, 502-1, 502-2, 503 Variable optical attenuator
504 Light source
510, 520 Optical tap
530 Gain control device
531 Monitoring unit
532 Control unit

1. An optical amplification apparatus comprising:
a polarization demultiplexer that demultiplexes first signal light into first polarized signal light and second polarized signal light which are two orthogonal polarization components;
a first excitation light multiplexer that multiplexes excitation light with each of the first polarized signal light and the second polarized signal light;
a first optical amplifier that generates an optical parametric amplification process to amplify the first polarized signal light and the second polarized signal light having been multiplexed with the excitation light by the first excitation light multiplexer;
a first excitation light separator that separates the excitation light from each of the first polarized signal light and the second polarized signal light having been amplified by the first optical amplifier;
an unnecessary band separator that removes an unnecessary frequency component from each of the first polarized signal light and the second polarized signal light from which the excitation light has been separated by the first excitation light separator;
a second excitation light multiplexer that outputs a third polarized signal light obtained by multiplexing the first polarized signal light from which the unnecessary frequency component has been removed by the unnecessary band separator and the excitation light having been separated from the first polarized signal light by the first excitation light separator and outputs a fourth polarized signal light obtained by multiplexing the second polarized signal light from which the unnecessary frequency component has been removed by the unnecessary band separator and the excitation light having been separated from the second polarized signal light by the first excitation light;
a second optical amplifier that generates an optical parametric amplification process to amplify the third polarized signal light and the fourth polarized signal light having been multiplexed with the excitation light by the second excitation light multiplexer;
a second excitation light separator that separates the excitation light from each of the third polarized signal light and the fourth polarized signal light having been amplified by the second optical amplifier;
a polarization multiplexer unit that outputs second signal light obtained by multiplexing the third polarized signal light and the fourth polarized signal light from which the excitation light has been separated by the second excitation light separator; and
a band-pass filter unit that removes an unnecessary frequency component from the second signal light output from the polarization multiplexer,
wherein the first optical amplifier is in a phase matching state in which amplification gain becomes larger as a frequency is separate from a center frequency that is ½ of a frequency of the excitation light, and
the second optical amplifier is in a phase matching state in which amplification gain increases near the center frequency.

2. The optical amplification apparatus according to claim 1, further comprising:
an adjuster that adjusts optical power of the excitation light to be output from the first excitation light separator to the second excitation light multiplexer.

3. The optical amplification apparatus according to claim 2, further comprising:
a controller that controls gain of the adjuster according to a monitoring result of the first signal light before being separated by the polarization demultiplexer and the second signal light output from the band-pass filter.

4. The optical amplification apparatus according to claim 1, further comprising:
an isolator that passes light in a direction from the first optical amplifier to the second optical amplifier and blocks light in a direction from the second optical amplifier to the first optical amplifier in one or both of a preceding stage and a subsequent stage of one or both of the first optical amplifier and the second optical amplifier.

5. The optical amplification apparatus according to claim 1,
wherein the band-pass filter unit passes amplified light in a band of the first signal light or a band of idler light.

6. An optical amplification method comprising:
demultiplexing first signal light into first polarized signal light and second polarized signal light which are two orthogonal polarization components;
a multiplexing excitation light with each of the first polarized signal light and the second polarized signal light;
generating a first optical parametric amplification process to amplify the first polarized signal light and the second polarized signal light having been multiplexed with the excitation light;
separating the excitation light from each of the first polarized signal light and the second polarized signal light having been amplified in the first optical parametric amplification process;
removing an unnecessary frequency component from each of the first polarized signal light and the second polarized signal light from which the excitation light has been separated;
outputting a third polarized signal light by multiplexing the first polarized signal light from which the unnecessary frequency component has been removed and the excitation light having been separated from the first polarized signal light and outputting a fourth polarized signal light by multiplexing the second polarized signal light from which the unnecessary frequency component has been removed and the excitation light having been separated from the second polarized signal light;
generating a second optical parametric amplification process to amplify the third polarized signal light and the fourth polarized signal light;
separating the excitation light from each of the third polarized signal light and the fourth polarized signal light having been amplified in the second optical parametric amplification process;
outputting second signal light obtained by multiplexing the third polarized signal light and the fourth polarized signal light from which the excitation light has been separated; and
removing an unnecessary frequency component from the second signal light,
wherein in the first optical parametric amplification process, the first polarized signal light and the second polarized signal light are amplified in a phase matching state in which amplification gain becomes larger as a frequency is separate from a center frequency that is ½ of a frequency of the excitation light, and
in the second optical parametric amplification process, the third polarized signal light and the fourth polarized signal light are amplified in a phase matching state in which amplification gain increases near the center frequency.
